(19) United States
(12) Patent Application Publication
(10) Pub. No.: US 2015/0271221 A1
(43) Pub. Date: Sep. 24, 2015

(54) SELECTION TRIGGERED COLLABORATIVE CAX EDITING

(71) Applicant: Brigham Young University, Provo, UT (US)

(72) Inventors: Ammon Hepworth, Provo, UT (US); Keith Halterman, Carver, MN (US); Brett Stone, Lehi, UT (US); Jared Yarn, Provo, UT (US); Charles Greg Jensen, Provo, UT (US)

(21) Appl. No.: 14/664,720

(22) Filed: Mar. 20, 2015

Related U.S. Application Data
(60) Provisional application No. 61/968,085, filed on Mar. 20, 2014.

(51) Int. Cl. H04L 29/06; G06F 3/0482; G06F 3/0484; H04L 12/58; G06F 17/50

(52) U.S. Cl. CPC H04L 65/403; H04L 51/046; G06F 17/50; G06F 3/04842; G06F 3/0482

(57) ABSTRACT

A method for collaborative CAx editing includes presenting at least a portion of a model of an engineering object to a user, wherein the model of the engineering object comprises a geometric element, and detecting selection of the geometric element by the user. The method may also include enabling the user to participate in a chat group and view a task list corresponding to the geometric element in response to detecting selection of the geometric element by the user. In some embodiments, the geometric element is a part and selection of the geometric element by the user comprises opening the part for editing. In other embodiments, the geometric element is a feature and selection of the feature comprises accessing a feature tree. A corresponding computer program product and computer system is also disclosed herein.

### REFERENCE TO RELATED APPLICATIONS

This application claims the benefit of U.S. Provisional Application 61/968,085 entitled “AN INTEGRATED TASK MANAGEMENT SYSTEM TO REDUCE SEMANTIC CONFLICTS IN MULTI-USER CAD” and filed on 20 Mar. 2014. The above specified application is incorporated herein by reference.

### BACKGROUND

The claimed invention relates to computer aided technologies (CAx) such as computer aided design, engineering, analysis and manufacture in general and to collaborative CAx editing in particular.

Large design and engineering projects require coordination of the efforts of many designers or engineers. Existing CAx systems, however, are not well-suited to collaborative design and editing. For example, users in a multi-user CAx environment may be unaware of the intentions and efforts of other users.

### BRIEF SUMMARY OF THE INVENTION

A method for collaborative CAx editing includes presenting at least a portion of a model of an engineering object to a user, wherein the model of the engineering object comprises a geometric element, and detecting selection of the geometric element by the user. The method may also include enabling the user to participate in a chat group and view a task list corresponding to the geometric element in response to detecting selection of the geometric element by the user. In some embodiments, the geometric element is a part and selection of the geometric element by the user comprises opening the part for editing. In other embodiments, the geometric element is a feature and selection of the geometric element by the user comprises accessing a feature tree. A corresponding computer program product and computer system is also disclosed herein.

It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of one example of a computing and communications infrastructure that is consistent with one or more embodiments of the claimed invention;

FIG. 2 is a schematic diagram illustrating one embodiment of a collaborative CAx editing system that is consistent with one or more embodiments of the claimed invention;

FIG. 3 is a flowchart diagram of one example of a collaborative CAx editing method that is consistent with one or more embodiments of the claimed invention;

FIG. 4 is a schematic diagram of one example of a collaborative CAx editing system that is consistent with one or more embodiments of the claimed invention; and

FIG. 5 is an illustration of one example of a collaborative CAx editing interface that is consistent with one or more embodiments of the claimed invention.

### DETAILED DESCRIPTION OF THE INVENTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a Bernoulli drive, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

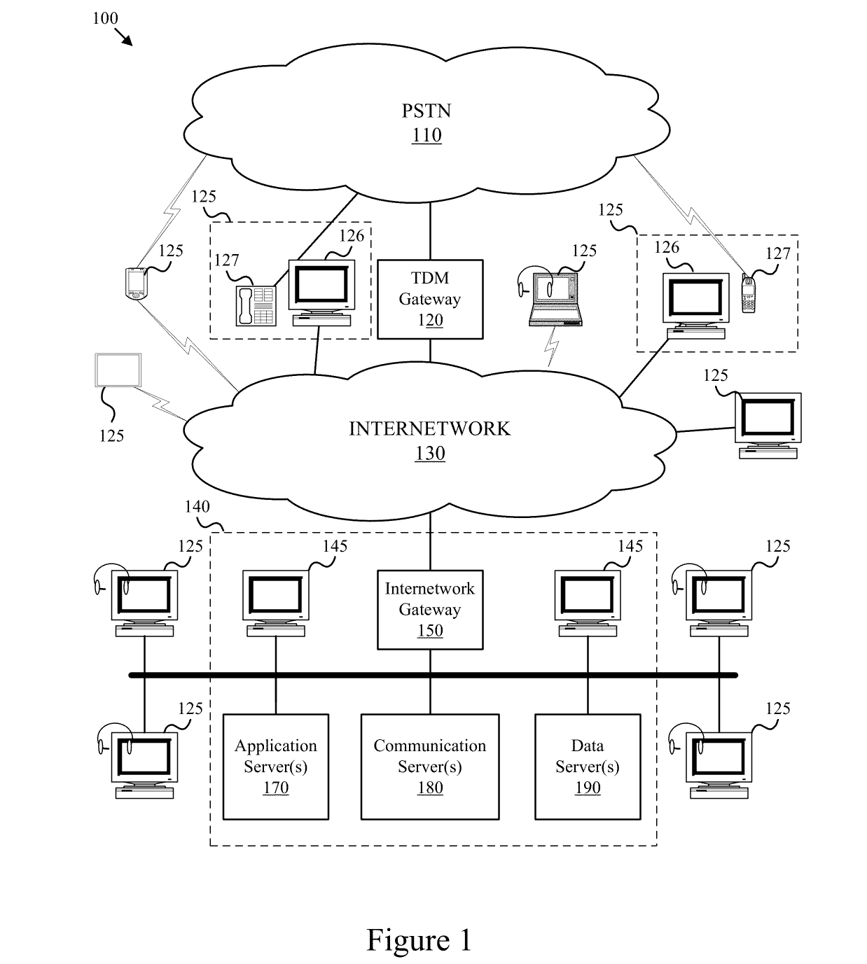

FIG. 1 is a block diagram of one example of a computing and communications infrastructure 100 that is consistent with one or more embodiments of the claimed invention. As depicted, the infrastructure 100 includes various systems, subsystems, and networks such as a public switched telephone network (PSTN) 110, a TDM gateway 120 connecting the PSTN to an inter-network 130, a variety of workstations 125, a data center 140 with administrative terminals 145, an inter-network gateway 150 connecting a local area network to the inter-network 130, and various servers such as application servers 170, communication servers 180, and data servers 190. The infrastructure 100 is one example of components that can be operably interconnected to provide an infrastructure for a computer-aided design, computer-aided engineering, or computer-aided manufacturing (CAx) system that includes a collaborative CAx editing system.

Each workstation 125 may include a separate computing device 126 and a communications device 127 or the computing device and communications device may integrated into the workstation 125. Examples of the communications device 127 include a phone, a VOIP device, an instant messaging device, a texting device, a browsing device, and the like. The computing devices 126 may enable graphical view selection. The communications devices 127 may enable users to communicate with other CAx system users.

The inter-network 130 may facilitate electronic communications between the various workstations and servers. In one embodiment, the inter-network 130 is the internet. In another embodiment, the inter-network 130 is a virtual private network (VPN).

Various servers such as blade servers within the data center 140 function cooperatively to facilitate concurrent collaborative editing of CAx models by local and remote users. For example, the application servers 170 may provide one or more CAx applications to the local and remote users. Some users may have the CAx applications installed on their local computing devices 126. Examples of CAx applications include Siemens NX, MSC Nastran, Dessault Systems CATIA and Solidworks, ANSYS, and the like.

The communication servers 180 may facilitate communications between the users through various channels or services such as VOIP services, email services, instant messaging services, short message services, and text messaging services. The workstations 125 may leverage such services for user to user communications via the communication servers 180 or via other available service platforms.

The data servers 190 or the like may store CAx models within various model files or records. The data servers may replicate copies of the models for use by various users. Some users may have a local copy of a model. As described herein, instead of requiring a particular user to assume control of a model file or record, updates to the model may be coordinated by one or more CAx applications including client versions, server versions, and cloud versions of such applications.

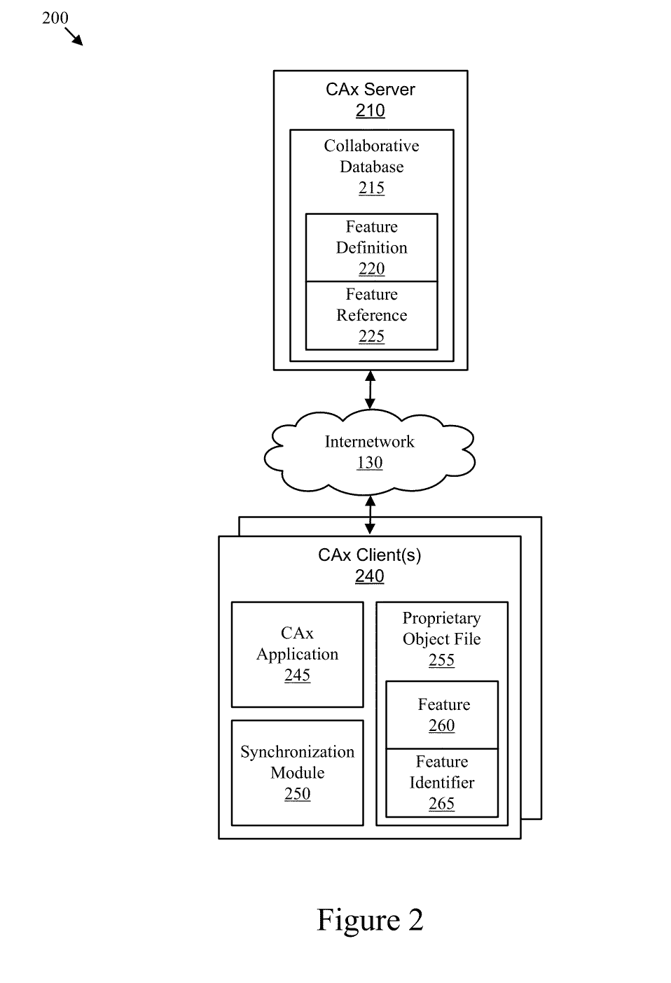

FIG. 2 is a block diagram of one example of a collaborative CAx editing system 200 that is consistent with one or more embodiments of the claimed invention. As depicted, and as will be explained in greater detail below, the collaborative CAx editing system 200 may include a variety of modules, including a CAx client 240 with at least one processor that may execute a proprietary CAx application 245 and enable editing of a proprietary representation of an engineering object by a user. The collaborative CAx editing system 200 may also include a collaborative CAx server 210 that may store a vendor-neutral model of an operations log of the engineering object. Collaborative CAx editing system 200 may also include a synchronization module 250 that may detect creation of a proprietary feature 260 of the engineering object within the proprietary CAx application 245 and insert a feature identifier 265 corresponding to the feature within the proprietary representation of the engineering object. The feature identifier 265 may correspond to, or be identical to, the feature reference 225.

As illustrated in FIG. 2, collaborative CAx editing system 200 may also include one or more data stores, such as proprietary object file 255 or collaborative database 215. In one embodiment, proprietary object file 255 may be configured to store a proprietary representation of an engineering object. Collaborative database 215 may be configured to store an operations log of the engineering object. Proprietary object file 255 and collaborative database 215 may represent portions of a single database or computing device or a plurality of databases or computing devices. For example, collaborative database 215 may represent portions of the computing and communications infrastructure 100 in FIG. 1.

Each of the modules may reside on a single computing device (i.e. node) or be collaboratively partitioned onto multiple devices or nodes. The modules may be primarily or wholly comprised of software codes and associated data that are executed and processed by a digital processing apparatus such as a computer to provide the specified functionality.

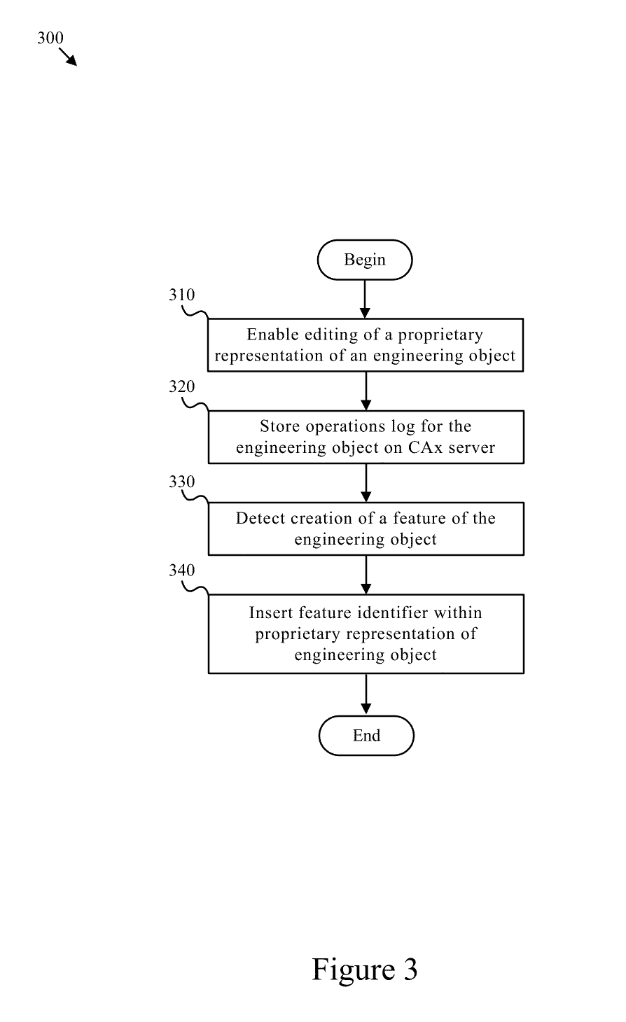

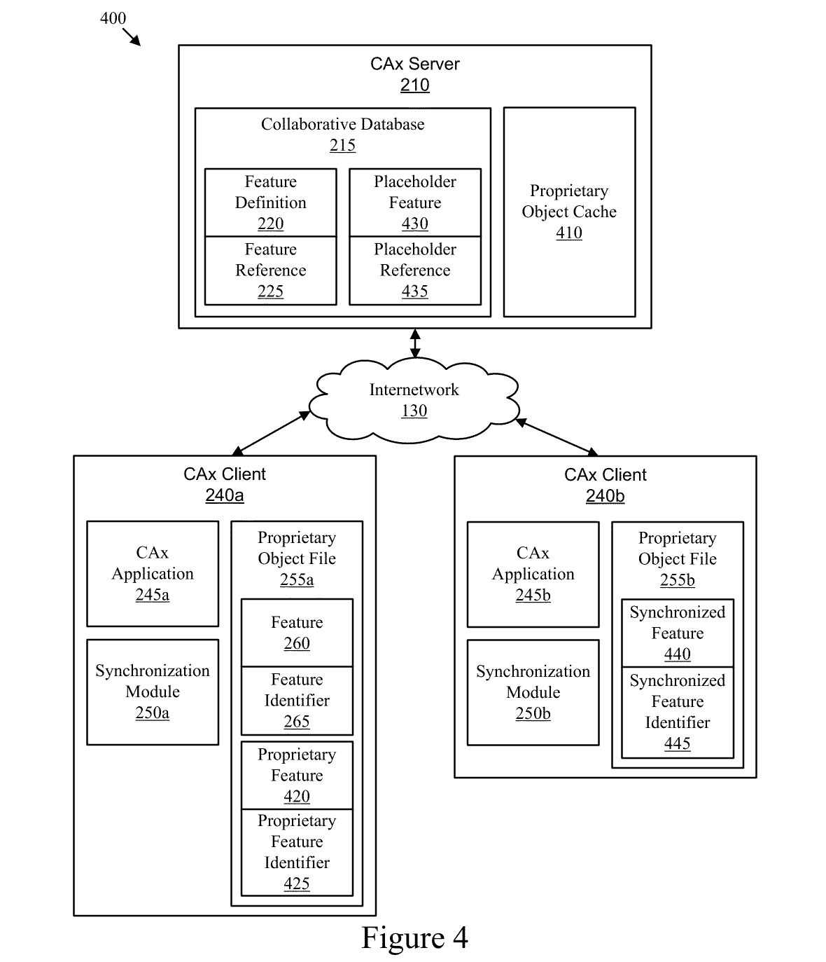

FIG. 3 is a flow diagram of a collaborative CAx editing method 300. The steps (i.e., operations) shown in FIG. 3 may be performed by any suitable computer-executable code and/or computing system and in some cases need not be executed sequentially or in the depicted order. In some embodiments, the steps shown in FIG. 3 may be performed by one or more components of computing and communications infrastructure 100 in FIG. 1, system 200 in FIG. 2, and/or system 400 in FIG. 4.

As illustrated in FIG. 3, at step 310 one or more of the systems described herein may execute a proprietary CAx application and enable editing of a proprietary representation of an engineering object by a user. For example, at step 310 CAx client 240 may, as part of computing device 200 in FIG. 2, execute CAx application 245 and enable editing of a proprietary representation of an engineering object by a user. CAx application 245 may store the proprietary representation of the engineering object in proprietary object file 255. The proprietary representation may include one or more features of the engineering object, such as proprietary feature 260.

As used herein, the phrase “engineering object” generally refers to a conceptual design produced to show the look or function of an object before it is built or made. The design may be incorporated in representations such as plans, drawings, diagrams, schematics, blueprints, sketches, maps, or models. The design may include one or more “features,” i.e., distinctive attributes that may be represented by one or more geometries or parameters.

As used herein, the phrase “proprietary representation” generally refers to a data format associated with a CAx application. A proprietary representation of an engineering object may be vendor specific and typically cannot be directly edited by a CAx application other than those available from the vendor or licensed by the vendor. Typically, a conversion process is required for a CAx application from another vendor to edit the engineering object. The conversion process may result in the loss of data.

At step 320 one or more of the systems described herein may store an operations log for the engineering object on a collaborative CAx server. For example, at step 320 collaborative CAx server 210 may, as part of computing device 200 in FIG. 2, store an operations log of the engineering object on a collaborative CAx server 210. The operations log may be stored in a collaborative database 215, and may include one or more feature definitions, such as feature definition 220.

As used herein, the phrase “operations log” generally refers to a log of CAx operations that may or may not be associated with a single proprietary CAx application. For example, the operations log may be a vendor-neutral log of feature definitions that facilitates collaborate editing between various proprietary CAx applications.

Collaborative CAx server 210 may store an operations log of the engineering object in various ways. In one embodiment, the operations log of the engineering object comprises a log of sequentially-generated feature definitions. The engineering object may be reconstructed within various CAx applications by regenerating the features comprising the engineering object in sequence. The feature definitions within the operations log may be readily translatable to editing commands within each CAx application by a synchronization module 250 associated therewith.

The operations log of the engineering object may include references to features within the proprietary representation of the engineering object. For example, as depicted in FIG. 2, feature definition 220, corresponding to proprietary feature 260 and to feature identifier 265, may have an associated feature reference 225 associating feature definition 220 with proprietary feature 260. In some embodiments, the feature identifier 265, corresponds directly to the feature reference 225. In one embodiment, the feature identifier 265 and the feature reference 225 are identical. Synchronization module 250 may use feature reference 225 to identify the corresponding proprietary feature 260 within proprietary object file 255 via the feature identifier 265. In one embodiment, feature reference 225 is a globally-unique identifier (GUID) associated with proprietary feature 260.

In one embodiment, the proprietary representation of the engineering object corresponds to a point-in-time within the log of sequentially-generated feature definitions. The point in time may correspond to a snapshot or revision marker within the log. In a collaborative CAx editing environment, editing of the engineering object may take place while a client is offline. The sequentially-generated feature definitions may continue to be created in the operations log of the engineering object. When the client reconnects with the operations log of the engineering object, subsequently-generated feature definitions created after the point-in-time are applied to the proprietary representation to synchronize the proprietary representation with the operations log.

Returning to FIG. 3, at step 330 one or more of the systems described herein may detect creation of a feature of the engineering object within the proprietary CAx application. For example, at step 330 collaborative CAx synchronization module 250 may, as part of CAx client 240 in FIG. 2, detect creation of a feature of the engineering object within the proprietary CAx application. For example, collaborative CAx synchronization module 250 may detect creating of proprietary feature 260 in proprietary object file 255.

The collaborative CAx synchronization module may detect creation of a feature of the engineering object within the proprietary CAx application in any suitable manner. In one embodiment, the collaborative CAx synchronization module is a plugin for the CAx application, and detects creation of a feature of the engineering object using an application programming interface (API) provided by the CAx application to permit additional functions to execute when a feature is created.

At step 340 of FIG. 3, one or more of the systems described herein may insert a feature identifier corresponding to the feature within the proprietary representation of the engineering object. For example, at step 340 synchronization module 250 may, as part of CAx client 240 in FIG. 2, insert feature identifier 265 corresponding to proprietary feature 260 within the proprietary representation of the engineering object stored in proprietary object file 255.

As used herein, the phrase “feature identifier” generally refers to a data item that relates a proprietary feature in a proprietary object file to a feature definition in a collaborative database. In one embodiment, the feature identifier is the index of the feature definition record in the collaborative database.

In one embodiment, the feature identifier is stored in a parameter for the feature within the proprietary representation of the engineering object. By storing the feature identifier within the proprietary representation of the engineering object, the relationship between the proprietary feature and the corresponding feature definition within the operations log is persistent between editing sessions on the CAx client. The feature identifier may be a globally unique identifier. In some embodiments, the feature identifier is represented in a text format to facilitate storage and retrieval within various CAx applications.

FIG. 4 is a schematic diagram of one example of a collaborative CAx editing system 400 that is consistent with one or more embodiments of the claimed invention. In addition to the internetwork 130 of the computing and communications infrastructure 100 of FIG. 1 and modules of the collaborative CAx editing system 200 of FIG. 2, collaborative CAx editing system 400 includes a second CAx client. Corresponding modules of the two CAx clients 240 are appended with reference letters ‘a’ and ‘b.’

In one embodiment, the proprietary representation and the operations log of the engineering object may be cached by the collaborative CAx server. For example, as part of collaborative CAx editing system 400 in FIG. 4, CAx server 210 may cache the proprietary representation of the engineering object in proprietary object cache 410. Regenerating a proprietary representation of an engineering object from sequentially-generated feature definitions in an operations log of the object may be a computationally-intensive and time-consuming process. Caching the proprietary representation of the engineering object on the CAx server with the operations log accelerates the loading of the engineering object on a CAx client on which the proprietary representation is usable by the CAx client and has not yet been loaded into memory (such as following a system crash of the CAx client, or when a new CAx client is added to the collaborative editing system).

In one embodiment, the proprietary representation of the engineering object may be provided to another (a second) CAx client. When the second CAx client adds or changes a feature in the proprietary representation, an instance of the collaborative CAx synchronization module corresponding to the second client may communicate the feature identifier and a corresponding feature definition to the CAx server. The collaborative CAx synchronization module (associated with the first CAx client) may then receive a feature identifier and the feature definition corresponding to the feature created the second CAx client and create a corresponding local feature. For example, as part of collaborative CAx editing system 400, synchronization module 250b on CAx client 240b may create feature definition 220 in collaborative database 215 on CAx server 210. CAx server 210 may notify synchronization module 250a on CAx client 240a of the new feature in the collaborative database 215. Synchronization module 250a may then create synchronized feature 440 in proprietary object file 255a on CAx client 240a, corresponding to feature 260 in proprietary object file 255b on CAx client 240b.

In some embodiments, the CAx synchronization module may initiate insertion of a placeholder feature and corresponding feature reference within the operations log of the engineering object for features not directly supported by the operations log of the engineering object. For example, as depicted in collaborative editing system 400 in FIG. 4, proprietary feature 420 may be created in proprietary object file 255a on CAx client 240a. Synchronization module 250a may initiate creation of placeholder feature 430 and associated placeholder reference 435 in collaborative database 215 on CAx server 210. Features represented by a placeholder may not be editable by another CAx application, but the placeholder reference 435 maintains an association between the database record for placeholder feature 430 and the proprietary representation of the data in the proprietary object file 255a. Placeholder features may be referenced by other features. For example, a sheet body that could not be created or edited in collaborative database 215 may be represented by a placeholder feature and referenced by a split body feature.

As explained above, the collaborative CAx system may associate features in a proprietary representation of an engineering object with corresponding feature definitions in an operations log of the engineering object. A synchronization module, which may be a plug-in to a CAx application executing on a CAx client, may synchronize features between the proprietary and operations logs of the engineering object. As new features are created and edited on one CAx client and synchronized to the vendor-neutral database, synchronization modules on other CAx clients may synchronize the features from the vendor-neutral database to local copies of the proprietary representation of the engineering object.

The collaborative CAx editing system may maintain identifiers and references associating the proprietary and operations log representations of features of the engineering object in non-transitory storage, to prevent the loss of data in the event of system failure of either a CAx client or the CAx server. Caching the proprietary representation of the engineering object in a proprietary object cache on the CAx server may facilitate faster recovery from the system failure of a CAx client.

The proprietary representation of an engineering object may be a “checkpoint” or point-in-time within a sequence of feature definitions created in operations log. The synchronization module may bring the proprietary representation “up to date” by creating features in the proprietary representation that were created in the operations log subsequent to the point-in-time represented by the proprietary representation.

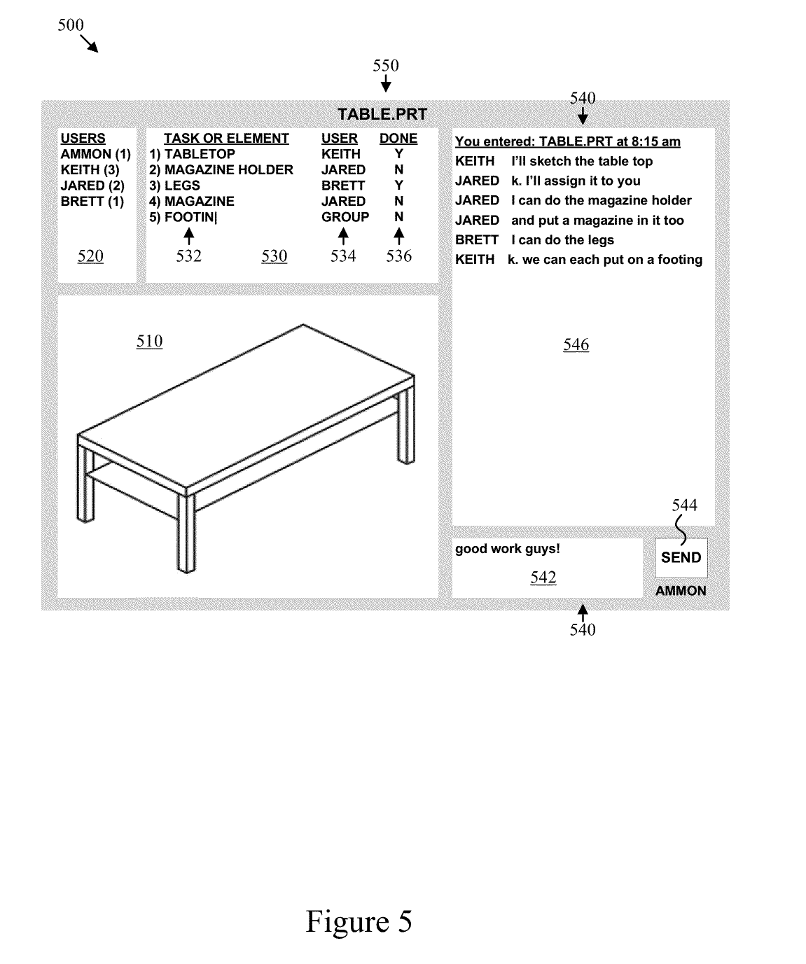

FIG. 5 is an illustration of one example of a collaborative editing interface 500 that is consistent with one or more embodiments of the claimed invention. As depicted, the collaborative editing interface 500 includes a model viewing pane 510, a user list 520, a task list 530, a chat interface 540, and an element identifier 550. The collaborative editing interface 500 enables collaborative multi-user editing. Each user in a collaborative editing environment (e.g., the infrastructure 100) may be provided with the collaborative editing interface 500 executing on a client, or the like, such as the CAx client 240 depicted in FIGS. 2 and 4.

The model viewing pane 510 enables a user to view and/or graphically edit a model of an object that is to be designed or otherwise engineered. The model of the object may be hierarchically structured into geometric units (elements) of editing such as assemblies, parts, geometries, features, and attributes (e.g., parameters). The model viewing pane 510 may present a graphical rendering of the model and may or may not enable graphical editing of the model. In some embodiments, the model viewing pane 510 is separable from, and/or may be shared by, multiple collaborative editing interfaces 500. In the depicted embodiment, the model viewing pane presents a graphical rendering of a part entitled “TABLE.PRT” to a user. The depicted part may be included in one or more assemblies.

Each user within a collaborative editing environment may be provided with their own view(s) of the model, or a portion thereof, via the particular collaborative editing interface(s) 500 and model viewing pane(s) 510 which they are using. For example, some users may have two or more collaborative editing interfaces 500 active on their computing device. For example, a user that is editing the tabletop shown in FIG. 5, may have a collaborative editing interface 500 active for a geometry corresponding to the tabletop, a part corresponding to the table, and one or more assemblies in which the part is included. Consequently, a user may be able to participate at multiple levels of the design process simultaneously. In the depicted embodiment, the number of geometric elements for which a user is collaborating on, is indicated in parenthesis after the username in the user list 520. In one embodiment, clicking on a username within the user list 520 actives a dialog box that indicates each geometric element which the user is currently collaborating on.

The user list 520 indicates which users are collaborating on a selected geometric element. The selected geometric element may be indicated by the element identifier 550. Each user may be added to the user list 520 and presented with the collaborative editing interface 500 in response to selecting the geometric element for viewing or editing. For example, the geometric element may be selected by entering a filename, graphically selecting an object or portion thereof in an editing window or hierarchical list (e.g., a feature tree), or selecting a filename from a list of geometric elements (e.g., a directory listing). In the depicted embodiment, there are four users that are collaborating on a selected geometric element (i.e., unit of editing) that is entitled “TABLE.PRT”.

In addition to being added to the user list 520 (e.g., in response to selection of the geometric element) the user may be presented with the task list 530, and the chat interface 540. The depicted task list 530 includes tasks identifiers 532, assigned user identifiers 534, and completion indicators 536. In the depicted embodiment, each portion of the task list 530 may be edited by any user within the user list 520 in order to enable complete collaboration amongst the collaborative users. For example, in the depicted embodiment each collaborative user may append to the task list by inserting text below the last entry of the task identifiers 532. In response thereto, the assigned user 534 may default to ‘GROUP’ (indicating the task is initially assigned to the group as a whole) and the completion status 536 may default to ‘N’ (indicating that the task is not yet complete).

Subsequent to task creation, in the depicted embodiment any user may change the assigned user 534 and the completion status 536. For example, in some embodiments any user may toggle the completion status by clicking on the displayed completion status 536. In one embodiment, clicking on a username within the assigned user list 534 actives a dialog box that indicates each task that has been assigned to a user. Users may also delete an entry from the task list 530. In the depicted embodiment, a user may delete a listing by selecting and deleting the corresponding task identifier 532. In some embodiments, a user may also right click on an entry and select a delete command.

The chat interface 540 enables communication amongst the collaborative users. A text entry control 542 enables users to enter and edit text messages. In the depicted embodiment an entered text message may be sent with send button 544. Sent text messages are displayed in each user's message window 546 prepended with the name of the user that sent the message.

One of skill in the art may appreciate the effectiveness of the collaborative editing interface 500. Each user is automatically added to a chat group corresponding to a geometric element that is selected for viewing or editing and informed as to which users are editing a geometric element, what the currently tasks are and who they are assigned to. In some embodiments, a user may simultaneously participate in the editing of multiple geometric elements which may be at different levels in a modeling hierarchy.

The preceding depiction of the collaborative CAx system and other inventive elements described herein are intended to be illustrative rather than definitive. Similarly, the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, executed by at least one processor, the method comprising:
presenting at least a portion of a model of an engineering object to a user, wherein the model of the engineering object comprises a geometric element;
detecting selection of the geometric element by the user;
enabling the user to participate in a chat group corresponding to the geometric element in response to detecting selection of the geometric element by the user.

2. The method of claim 1, wherein enabling the user to participate in the chat group comprises adding the user to the chat group.

3. The method of claim 2, wherein the user is automatically added to the chat group in response to detecting selection of the geometric element by the user.

4. The method of claim 1, wherein enabling the user to participate in the chat group comprises providing a chat interface for participating in the chat group.

5. The method of claim 1, wherein selection of the geometric element comprises opening the geometric element for viewing or editing.

6. The method of claim 1, wherein selection of the geometric element comprises accessing a hierarchical list corresponding to the model.

7. The method of claim 1, further comprising displaying a task list for the geometric element to the user.

8. The method of claim 1, wherein presenting at least a portion of the model of an engineering object comprises communicating with a multi-user server.

9. The method of claim 1, wherein presenting at least a portion of the model of an engineering object occurs via a CAx editing tool.

10. A method, executed by one or more processors, the method comprising:
presenting at least a portion of a model of an engineering object to a user, wherein the model of the engineering object comprises a geometric element;
detecting selection of the geometric element by the user; and
enabling the user to view a task list for the geometric element in response to detecting selection of the geometric element by the user.

11. The method of claim 10, wherein enabling the user to view the task list comprises displaying the task list to the user.

12. The method of claim 10, wherein selection of the geometric element comprises opening the geometric element for viewing or editing.

13. The method of claim 10, wherein selection of the feature comprises accessing a hierarchical list corresponding to the model.

14. The method of claim 10, wherein presenting at least a portion of a model of an engineering object comprises communicating with a multi-user server.

15. The method of claim 10, wherein presenting at least a portion of a model of an engineering object occurs via a CAx editing tool

16. The method of claim 10, wherein the user is automatically added to the chat group in response to detecting selection of the geometric element by the user.

17. A computer program product comprising:
a computer readable medium having program instructions stored thereon, the program instructions comprising instructions to:
present at least a portion of a model of an engineering object to a user, wherein the model of the engineering object comprises a geometric element;
detect selection of the geometric element by the user;
enable the user to participate in a chat group and view a task list corresponding to the geometric element in response to detecting selection of the geometric element by the user.

18. The computer program product method of claim 17, wherein the instructions to enable the user to participate in the chat group and view the task list comprises instructions to automatically add the user to the chat group and instructions to display the task list to the user.

19. The computer program product method of claim 17, wherein the instructions to detect selection of the geometric element by the user comprise instructions to detect the user opening the geometric element for viewing or editing.

20. The method of claim 10, wherein the geometric element is a feature tree and the instructions to detect selection of the geometric element by the user comprise instructions to detect access to a hierarchical list corresponding to the model.
